(19) United States
(12) Patent Application Publication
(10) Pub. No.: US 2025/0003091 A1
(43) Pub. Date: Jan. 2, 2025

(54) A Separator for Alkaline Water Electrolysis

(71) Applicant: Agfa-Gevaert NV, Mortsel (BE)

(72) Inventors: Hanne Verwaest, Mortsel (BE); Willem Mues, Mortsel (BE); Cristina Tudisco, Mortsel (BE)

(73) Assignee: Agfa-Gevaert NV, Mortsel (BE)

(21) Appl. No.: 18/576,447

(22) PCT Filed: Jun. 24, 2022
(86) PCT No.: PCT/EP2022/067352

§ 371 Date: Jan. 4, 2024

(30) Foreign Application Priority Data
Jul. 8, 2021 (EP) 21184443.6

(51) Int. Cl. C25B 13/02; C25B 1/04; C25B 13/08

(52) U.S. Cl. CPC C25B 13/02; C25B 1/04; C25B 13/08

(57) ABSTRACT

A separator for alkaline electrolysis (1) comprising a porous support (100) and a porous layer (200) provided the porous support, characterized in that at least (25) volume percent of the pores of the separator are filled with water.

### TECHNICAL FIELD OF THE INVENTION

The present invention relates to a separator for alkaline water electrolysis and to a manufacturing method thereof.

### BACKGROUND ART FOR THE INVENTION

Nowadays, hydrogen is used in several industrial processes, for example its use as raw material in the chemical industry and as a reducing agent in the metallurgic industry. Hydrogen is a fundamental building block for the manufacture of ammonia, and hence fertilizers, and of methanol, used in the manufacture of many polymers. Refineries, where hydrogen is used for the processing of intermediate oil products, are another area of use.

Hydrogen is also being considered an important future energy carrier, which means it can store and deliver energy in a usable form. Energy is released by an exothermic combustion reaction with oxygen thereby forming water. During such combustion reaction, no greenhouse gases containing carbon are emitted.

For the realization of a low-carbon society, renewable energies using natural energy such as solar light and wind power are becoming more and more important.

The production of electricity from wind power and solar power generation systems is very much dependent on the weather conditions and therefore variable, leading to an imbalance of demand and supply of electricity. To store surplus electricity, the so-called power-to-gas technology wherein electrical power is used to produce gaseous fuel such as hydrogen, attracted much interest in recent years. As production of electricity from renewable energy sources will increase, the demand for storage and transportation of the produced energy will also increase.

Alkaline water electrolysis is an important manufacturing process wherein electricity may be converted into hydrogen.

In an alkaline water electrolysis cell, a so-called separator or diaphragm is used to separate the electrodes of different polarity to prevent a short circuit between these electronic conducting parts (electrodes) and to prevent the recombination of hydrogen (formed at the cathode) and oxygen (formed at the anode) by avoiding gas crossover. While serving in all these functions, the separator should also be a highly ionic conductor for transportation of hydroxyl ions from the cathode to the anode.

A separator typically includes a porous support. Such a porous support reinforces the separator facilitating the manipulation of the separator and the introduction of the separator in an electrolyser as disclosed in EP-A 232 923 (Hydrogen Systems).

EP-A 1776490 (VITO) discloses a process of preparing a reinforced separator. The process leads to a membrane with symmetrical characteristics. The process includes the steps of providing a porous support as a web and a suitable dope solution, guiding the web in a vertical position, equally coating both sides of the web with the dope solution to produce a web coated support, and applying a symmetrical surface pore formation step and a symmetrical coagulation step to the dope coated web to produce a reinforced membrane.

WO2009/147084 and WO2009/147086 (Agfa Gevaert and VITO) disclose manufacturing methods to produce a reinforced membrane with symmetrical characteristics as described in EP-A 1776490.

Physical damage of a separator may result in all sorts of problems during electrolysis, such as decrease of the ionic conductivity or an increase of the HTO and OTH.

There is thus a need for a separator having improved physical/mechanical properties.

### SUMMARY OF THE INVENTION

It is an object of the invention to provide a separator having improved mechanical/physical properties, such as a higher crack resistance, less brittleness and more flexibility, and an improved wettability by electrolyte used in alkaline water electrolyse.

This object is realized with a separator as defined in claim 1.

It is another object of the invention to provide a method of preparing such a separator.

Further objects of the invention will become apparent from the description hereinafter.

### BRIEF DESCRIPTION OF THE DRAWINGS

FIG. 1 shows schematically an embodiment of a separator according to the present invention.

FIG. 2 shows schematically another embodiment of a separator according to the present invention.

FIG. 3 shows schematically some examples of a pore diameter distribution in the thickness direction of a separator.

FIG. 4 shows schematically an embodiment of a manufacturing method of a separator as shown in FIG. 2.

FIG. 5 shows schematically another embodiment of a manufacturing method of a separator as shown in FIG. 2.

FIG. 6 shows schematically a Z-fold used for evaluating the mechanical properties of separators.

### DETAILED DESCRIPTION OF THE INVENTION

### Separator for Alkaline Water Electrolysis

The separator for alkaline electrolysis (1) according to the present invention comprises a porous support (100) and a porous layer (200) provided on the porous support, characterized in that at least 25 volume percent, more preferably at least 40 volume percent, most preferably at least 50 volume % of the pores of the separator are filled with water. In a particularly preferred embodiment, at least 75 volume % of the pores are filled with water.

The volume % of the pores that are filled with water (Vol % P) is determined by the method described below in the Examples.

The water content, i.e. the Volume % of pores filled with water, may be optimized by drying the separator, for example after the liquid induced phase separation step or washing step described below. Drying time and/or temperature may be optimized to obtain a separator according to the present invention.

As the water content influences the mechanical properties of the separator, it is important to use a packaging wherein the Volume % of pores filled with water of the packaged separator does not change substantially as function of time. The Volume % of pores filled with water preferably does not decrease more than 25%, more preferably more than 10%, most preferably more than 5% during preferably 6 months, more preferably 12 months, most preferably 24 months. A preferred packaging is described below.

To ensure a sufficient water content before packaging, the time between the end of the manufacturing process of a separator according to the invention described below and packaging the separator is preferably less than 1 hour, more preferably less than 45 minutes, more preferably less than 30 minutes, most preferably less than 15 minutes.

A separator for alkaline electrolysis (1) typically comprises a porous support (100) and a porous layer (200) provided on a side of the porous support (see FIG. 1). The porous layer (200) is preferably provided on a side of a porous support as described below.

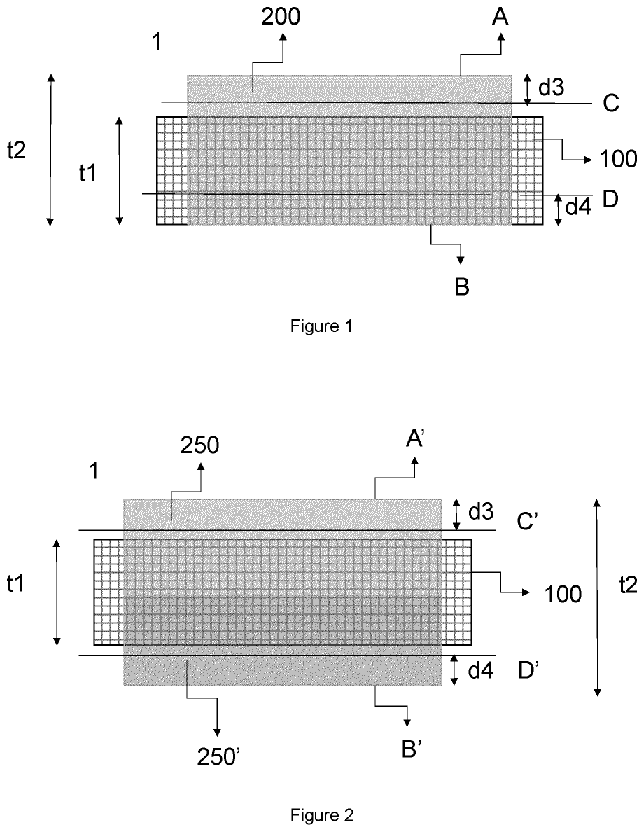

FIG. 2 schematically depicts another embodiment of a separator according to the present invention wherein a first (250) porous layer is provided on one side of the porous support (100) and a second (250′) porous layer is provided on the other side of the porous support (100). The first (250) and second (250′) porous layers may be identical or different from each other. The porous layers are preferably provided on the support as described below.

The thickness of the separator (t2) is preferably from 50 to 750 μm, more preferably from 75 to 500 μm, most preferably from 100 to 250 μm, particularly preferred from 125 to 200 μm. Increasing the thickness of the separator typically results in a higher physical strength of the separator. However, increasing the thickness of the separator typically also results in a decrease of the electrolysis efficiency due to an increase of the ionic resistance.

The separator preferably has an ionic resistance at 80° C. in a 30 wt % aqueous KOH solution of 0.1 ohm·cm² or less, more preferably of 0.07 ohm·cm² or less. The ionic resistance may be determined with an Inolab® Multi 9310 IDS apparatus available from VWR, part of Avantor, equipped with a TetraCon 925 conductivity cell available from Xylem.

As described below in more detail a separator according to the present invention is preferably prepared by the application of a coating solution, also referred to herein as a dope solution, on one or both sides of a porous support.

The dope solution preferably comprises a polymer resin, hydrophilic inorganic particles and a solvent.

A porous layer is then obtained after a phase inversion step wherein the polymer resin forms a three-dimensional porous polymer network.

Upon application of the dope solution(s) on one or both sides of the porous support, the dope solution(s) preferably impregnate the porous support. The porous support is more preferably completely impregnated with the dope solution(s). Such impregnation of the dope solution(s) into the porous support ensures that after phase inversion the three-dimensional porous polymer network also extends into the porous support, resulting in an improved adhesion between the porous layer and porous support.

The separator includes pores having a pore diameter that is sufficiently small to prevent recombination of hydrogen and oxygen by avoiding gas crossover in the longitudinal direction of the separator. On the other hand, to ensure efficient transportation of hydroxyl ions from the cathode to the anode the pore diameter may not be too small to ensure an efficient penetration of electrolyte into the separator.

The pores are preferably characterized using the Bubble Point Test method described in American Society for Testing and Materials Standard (ASMT) Method F316. This technique is based on the displacement of a wetting liquid embedded in the separator by applying an inert pressurised gas. Only through-pores are measured in this way.

The most challenging part for the gas to displace the liquid along the entire pore path is the most constricted section of the pore, also known as pore throat. The diameter of a pore measured with the Bubble Point Test method is the diameter of that pore throat, regardless of where the pore throat is positioned in the pore path.

The pores preferably have a maximum pore diameter (PDmax) measured with the Bubble Point Test method of from 0.05 to 2 μm, more preferably from 0.10 to 1 μm, most preferably from 0.15 to 0.5 μm.

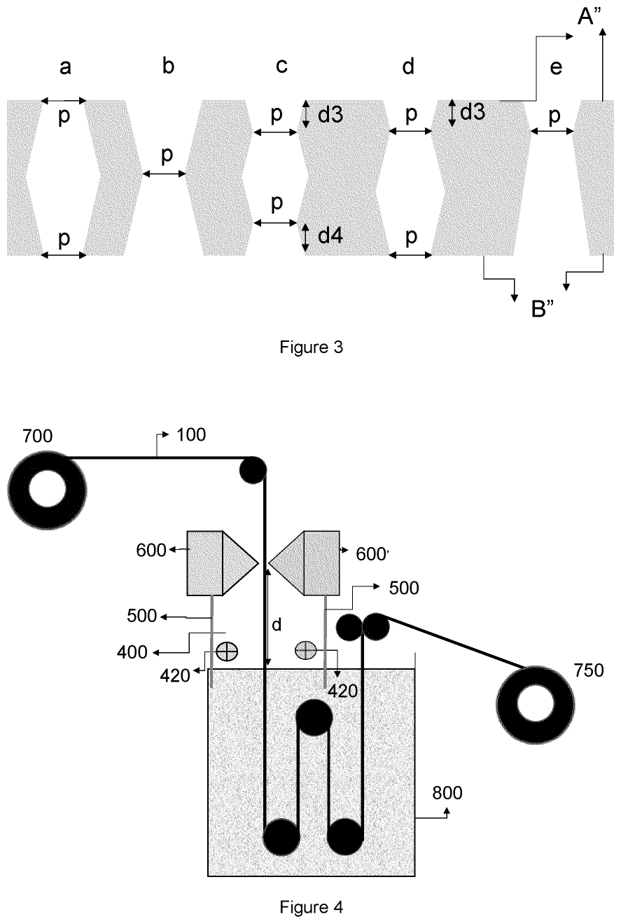

FIG. 3 schematically depicts so called through-pores a to e having various shapes. Through-pores referred to herein are pores that enables transport from one side to the separator to the other side of the separator. The pore throat (p) is shown for the different pore shapes.

For clarity reasons the porous support and porous layer(s) of the separator are not separately shown in FIG. 3. The separator in FIG. 3 may be the separator shown in FIG. 1 or FIG. 2.

The pore throat may be situated:
at the outer surface(s) of the separator of the separator (a);
“inside” the separator (b, c, e); or
both at an outer surface of the separator and “inside” the separator (d).

According to a preferred embodiment, the pore throat is situated at a distance d3 and/or d4 from one or both outer surfaces of the separator. The distances d3 and d4 may be identical or different from each other. The distances d3 and d4 are preferably from 0 to 15 μm, more preferably from 0 to 10 μm from respectively the outer surfaces A″ and B″ of the separator.

The pore diameter at both outer surfaces may be substantially identical or different from each other. Substantially identical referred to herein means that a ratio of the pore diameter of both surfaces is from 0.9 to 1.1. Pore diameters at the outer surface of a separator may also be measured with Scanning Electrode Microscopy (SEM) as disclosed in EP-A 3652362.

For a pore shape (a) in FIG. 3 the pore diameter measured with SEM at the outer surfaces of the separator will correspond with the maximum pore diameter PDmax measured with the Bubble Point Test method.

When a pore throat is however situated inside the separator (see pore shapes (b), (c), (d) and (e) in FIG. 3) the maximum pore diameter (PDmax) measured with the Bubble Point Test method will be smaller compared to the pore diameter measured at the outer surfaces with SEM.

The Bubble Point Test method may be adapted to measure a maximum pore diameter (PDmax) on both sides of a separator by using a grid supporting one side of the separator during the measurement. Another measurement is then carried out using the grid supporting to other side of the separator.

Also, the PDmax measured for both sides of the separator may be substantially identical or different from each other.

A preferred separator of which both sides have substantial identical pore diameters measured with the Bubble Point Test method is disclosed in EP-A 1776480, WO2009/147084 and EP-A 3312306.

A preferred separator of which both sides have different pore diameters measured with the Bubble Point Test method is disclosed in EP-A 3652362.

The maximum pore diameter at the outer surface of a first porous layer PDmax(1) is preferably between 0.05 and 0.3 μm, more preferably between 0.08 and 0.25 μm, most preferably between 0.1 and 0.2 μm and the maximum pore diameter at the outer surface of a second porous layer PDmax(2) is preferably between 0.2 and 6.5 μm, more preferably between 0.2 and 1.50 μm, most preferably between 0.2 and 0.5 μm. The ratio between PDmax(2) and PDmax(1) is preferably between 1.1 to 20, more preferably between 1.25 and 10, most preferably between 2 and 7.5. The smaller PDmax(1) ensure an efficient separation of hydrogen and oxygen while PDmax(2) ensures a good penetration of the electrolyte in the separator resulting in a sufficient ionic conductivity.

The porosity of the separator is preferably between 30 and 70%, more preferably between 40 and 60%. A separator having a porosity within the above ranges typically has excellent ion permeability and excellent gas barrier properties because the pores of the diaphragm are continuously filled with an electrolyte solution. A porosity of 80% or higher would result in a too low mechanical strength of the separator and a too high permeation of electrolyte, the latter resulting in an increase of the HTO (wt % hydrogen present in the oxygen formed at the anode).

The separator preferably has a water permeability from 200 to 800 l/bar·h·m², more preferably from 300 to 600 l/bar·h·m².

### Packaging

As its water content influences the mechanical properties of a separator, it is important to use a packaging that ensures the water content to remain constant, even when the packaged membranes are stored for months at varying temperatures and/or relative humidities.

The separator is typically cut in sheets of varying dimensions and a certain amount of these sheets are then packaged. An interleave may be used to separate the sheets within the package.

The water vapour transmission rate (WVTR) of packaging material gives an indication of the diffusion of water vapour in and out the packaging.

The WVTR of the packaging for the separators according to the present invention is preferably less than 5 g/m²/24 hours, more preferably less than 2.5 g/m²/24 hours, most preferably less than 1 g/m²/24 hours, particularly preferred less than 0.5 g/m²/24 hours. However, the WVTR of the packaging may be less than 0.1 g/m²/24 hours or even less than 0.01 g/m²/24 hours

Any packaging material may be used having the WVTR values described above.

A typical packaging material comprises a barrier laminate prepared from different foils/materials, such as for example aluminium, polyethylene (PE), polyethylene terephthalate (PET), oriented polypropylene (OPP) or non-woven materials. Such a barrier laminate is typically provided on a core, such as cardboard.

A preferred barrier laminate is for example a PET/PE laminate, for example a PET/PE laminate of a 12 μm (+/−10%) PET foil and a 75 μm (+/−15%) PE foil. This barrier laminate is then preferably provided a cardboard, for example a 76 mm thick cardboard.

### Porous Support

The porous support is used to reinforce the separator to ensure its mechanical strength.

A thickness of the porous support (t1) is preferably 350 μm or less, more preferably 200 μm or less, most preferably 100 μm or less, particularly preferred 75 μm or less.

It has been observed that the ion conductivity through a reinforced separator increases when the thickness of the porous support decreases.

However, to ensure sufficient mechanical properties of the reinforced separator, the thickness of the porous support is preferably 20 μm or more, more preferably 40 μm or more.

The porous support may be selected from the group consisting of a porous fabric and a porous ceramic plate.

The porous support is preferably a porous fabric, more preferably a porous polymer fabric.

The porous polymer fabric may be woven or non-woven. Woven fabrics typically have a better dimensional stability and homogeneity of open area and thickness. However, the manufacture of woven fabrics with a thickness of 100 μm or less is more complex resulting in more expensive fabrics. The manufacture of non-woven fabrics is less complex, even for fabrics having a thickness of 100 μm or less. Also, non-woven fabrics may have a larger open area.

The open area of the porous support is preferably between 30 and 80%, more preferably between 40 and 70%, to ensure a good penetration of the electrolyte into the support.

Suitable porous polymer fabrics are prepared from polypropylene, polyethylene (PE), polysulfone (PS), polyphenylene sulfide (PPS), polyamide/nylon (PA), polyether sulfone (PES), polyphenyl sulfone (PPSU), polyethylene terephthalate (PET), polyether-ether ketone (PEEK), sulfonated polyether-ether keton (s-PEEK), monochlorotrifluoroethylene (CTFE), copolymers of ethylene with tetrafluorethylene (ETFE) or chlorotrifluorethylene (ECTFE), polyimide, polyether imide and m-aramide.

A preferred polymer fabric is prepared from polypropylene (PP) or polyphenylene sulphide (PPS), most preferably from polyphenylene sulphide (PPS).

A polyphenylene sulfide based porous support has a high resistance to high-temperature, high concentration alkaline solutions and a high chemical stability against active oxygen evolved from an anode during the water electrolysis process. Also, polyphenylene sulphide can be easily processed into various forms such as a woven fabric or a non-woven fabric.

The density of the porous support is preferably between 0.1 to 0.7 g/cm³.

The porous support is preferably a continuous web to enable a manufacturing process as disclosed in EP-A 1776490 and WO2009/147084.

The width of the web is preferably between 30 and 300 cm, more preferably between 40 and 200 cm.

### Polymer Resin

The porous layer preferably comprises a polymer resin.

The polymer resin forms a three dimensional porous network, the result of a phase inversion step in the preparation of the separator, as described below.

The polymer resin may be selected from a fluorine resin such as polyvinylidene fluoride (PVDF) and polytetrafluoroethylene (PTFE), an olefin resin such as polypropylene (PP), and an aromatic hydrocarbon resin such as polyethylene terephthalate (PET) and polystyrene (PS). The polymer resins may be used alone, or two or more of the polymer resins may be used in combination.

PVDF and vinylidenefluoride (VDF)-copolymers are preferred for their oxidation/reduction resistance and film-forming properties. Among these, terpolymers of VDF, hexanefluoropropylene (HFP) and chlorotrifluoroethylene (CTFE) are preferred for their excellent swelling properties, heat resistance and adhesion to electrodes.

Another preferred polymer resin is an aromatic hydrocarbon resin for their excellent heat and alkali resistance. Examples of an aromatic hydrocarbon resin include polyethylene terephthalate, polybutylene terephthalate, polybutylene naphthalate, polystyrene, polysulfone, polyethersulfone, polyphenylene sulfide, polyphenyl sulfone, polyacrylate, polyetherimide, polyimide, and polyamide-imide.

A particular preferred polymer resin is selected from the group consisting of polysulfone, polyethersulfone and polyphenylsulfone, polysulfone being the most preferred.

The molecular weight (Mw) of polysulfones, polyether sulfones and polyphenyl sulfones is preferably between 10 000 and 500 000, more preferably between 25 000 and 250 000. When the Mw is too low, the physical strength of the porous layer may become insufficient. When the Mw is too high, the viscosity of the dope solution may become too high.

Examples of polysulfones, polyether sulfones and combinations thereof are disclosed in EP-A 3085815, paragraphs [0021] to [0032].

### Inorganic Hydrophilic Particles

The hydrophilic layer preferably comprises hydrophilic particles.

Preferred hydrophilic particles are selected from metal oxides and metal hydroxides.

Preferred metal oxides are selected from the group consisting of zirconium oxide, titanium oxide, bismuth oxide, cerium oxide and magnesium oxide.

Preferred metal hydroxides are selected from the group consisting of zirconium hydroxide, titanium hydroxide, bismuth hydroxide, cerium hydroxide and magnesium hydroxide. A particularly preferred magnesium hydroxide is disclosed in EP-A 3660188, paragraphs [0040] to [0063].

Other preferred hydrophilic particles are barium sulfate particles.

Other hydrophilic particles that may be used are nitrides and carbides of Group IV elements of the periodic tables.

The hydrophilic particles preferably have a D₅₀ particle size of 0.05 to 2.0 μm, more preferably of 0.1 to 1.5 μm, most preferably of 0.15 to 1.00 μm, particularly preferred of 0.2 to 0.75 μm. The D₅₀ particle size is preferably less than or equal to 0.7 μm, preferably less than or equal to 0.55 μm, more preferably less than or equal to 0.40 μm.

The D₅₀ particle size is also known as the median diameter or the medium value of the particle size distribution. It is the value of the particle diameter at 50% in the cumulative distribution. For example, if D₅₀₌0.1 um, then 50% of the particles are larger than 1.0 um, and 50% are smaller than 1.0 um.

The D₅₀ particle size is preferably measured using laser diffraction, for example using a Mastersizer from Malvern Panalytical.

The amount of the hydrophilic particles relative to the total dry weight of the porous layer is preferably at least 50 wt %, more preferably at least 75 wt %.

The weight ratio of hydrophilic particles to polymer resin is preferably more then 60/40, more preferably more than 70/30, most preferably more than 75/25.

### Preparation of the Separator

A preferred preparation method of a separator according to a first embodiment comprises the steps of:
applying a dope solution as described below on a side of a porous support(100); and
performing phase inversion on the applied dope solution thereby forming a a porous layer (200).

The applied dope solution preferably completely impregnates the porous support before performing the phase inversion.

A preferred method of manufacturing a reinforced separator is disclosed in EP-A 1776490 and WO2009/147084 for symmetric separators and EP-A 3652362 for asymmetric separators. These methods result in web-reinforced separators wherein the web, i.e. the porous support, is nicely embedded in the separator, without appearance of the web at a surface of the separator.

Other manufacturing methods that may be used are disclosed in EP-A 3272908, EP-A 3660188 and EP-A 3312306.

### Dope Solution

The dope solution preferably comprises a polymer resin as described above, hydrophilic particles as described above and a solvent.

The solvent of the dope solution is preferably an organic solvent wherein the polymer resin can be dissolved. Moreover, the organic solvent is preferably miscible in water.

The solvent is preferably selected from N-methyl-pyrrolidone (NMP), N-ethyl-pyrrolidone (NEP), N-butyl-pyrrolidone (NBP), N,N-dimethyl-formamide (DMF), formamide, dimethylsulfoxide (DMSO), N,N-dimethyl-acetamide (DMAC), acetonitrile, and mixtures thereof.

A highly preferred solvent, for health and safety reasons, is N-butyl-pyrrolidone (NBP).

The dope solution may further comprise other ingredients to optimize the properties of the obtained polymer layers, for example their porosity and the maximum pore diameter at their outer surface.

The dope solution preferably comprises an additive to optimize the pore size at the surface and inside of the porous layer. Such additives may be organic or inorganic compounds, or a combination thereof.

Organic compounds which may influence the pore formation in the porous layers include polyethylene glycol, polyethylene oxide, polypropylene glycol, ethylene glycol, tripropylene glycol, glycerol, polyhydric alcohols, dibutyl phthalate (DBP), diethyl phthalate (DEP), diundecyl phthalate (DUP), isononanoic acid or neo decanoic acid, polyvinylpyrrolidone, polyvinyl-alcohol, polyvinylacetate, polyethyleneimine, polyacrylic acid, methylcellulose and dextran.

Preferred organic compounds which may influence the pore formation in the porous layers are selected from polyethylene glycol, polyethylene oxide and polyvinylpyrrolidone.

A preferred polyethylene glycol has a molecular weight of from 10 000 to 50 000, a preferred polyethylene oxide has a molecular weight of from 50 000 to 300 000, and a preferred polyvinylpyrrolidone has a molecular weight of from 30 000 to 1 000 000.

A particularly preferred organic compound which may influence the pore formation in the porous layers is glycerol.

The amount of compounds which may influence the pore formation is preferably between 0.1 and 15 wt %, more preferably between 0.5 and 5 wt % relative to the total weight of the dope solution.

Inorganic compounds which may influence the pore formation include calcium chloride, magnesium chloride, lithium chloride and barium sulfate.

A combination of two or more additives that influence the pore formation may be used.

The dope solutions provided on either side of the porous support may be the same or different.

### Applying the Dope Solution

The dope solution may be applied on the surface of a substrate, preferably a porous support, by any coating or casting technique.

A preferred coating technique is extrusion coating.

In a highly preferred embodiment, the dope solutions are applied by a slot die coating technique wherein two slot coating dies (FIGS. 4 and 5, 600 and 600′) are located on either side of a porous support.

The slot coating dies are capable of holding the dope solution at a predetermined temperature, distributing the dope solutions uniformly over the support, and adjusting the coating thickness of the applied dope solutions.

The viscosity of the dope solutions measured at a shear rate of 100 s⁻¹ and a temperature of 20° C. is at least 20 Pa·s, more preferably at least 30 Pa·s, most preferably at least 40 Pa·s.

The dope solutions are preferably shear-thinning. The ratio of the viscosity at a shear rate of 1 s⁻¹ to the viscosity at a shear rate of 100 s⁻¹ is preferably at least 2, more preferably at least 2.5, most preferably at least 5.

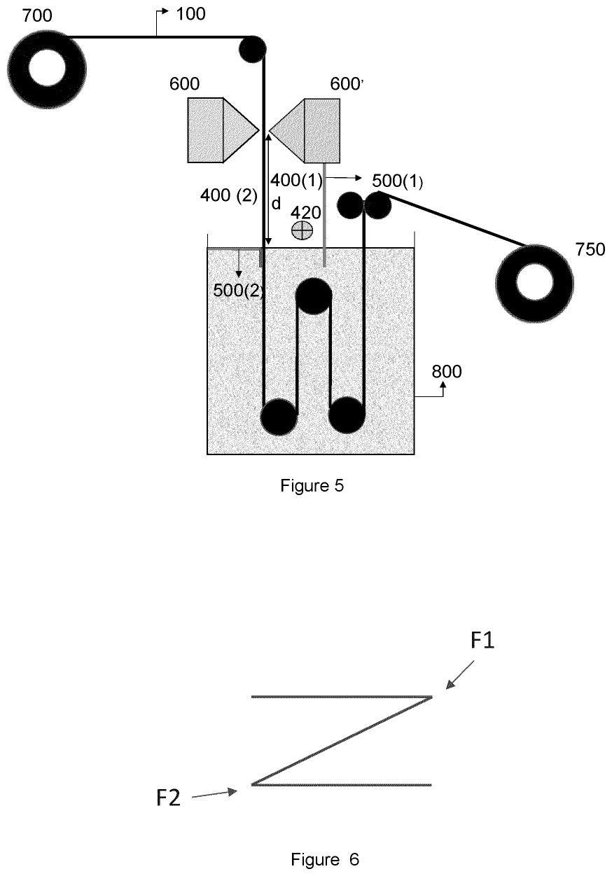

The porous support is preferably a continuous web, which is transported downwards between the slot coating dies (600, 600′) as shown in FIGS. 4 and 5.

Immediately after the application, the porous support becomes impregnated with the dope solutions.

Preferably, the porous support becomes fully impregnated with the applied dope solutions.

### Phase Inversion Step

After applying the dope solution onto a porous support, the applied dope solution is subjected to phase inversion. In the phase inversion step, the applied dope solution is transformed into a porous hydrophilic layer.

In a preferred embodiment, both dope solutions applied on a porous support are subjected to phase inversion.

Any phase inversion mechanism may be used to prepare the porous hydrophilic layers from the applied dope solutions.

The phase inversion step preferably includes a so-called Liquid Induced Phase Separation (LIPS) step, a Vapour Induced Phase Separation (VIPS) step or a combination of a VIPS and a LIPS step. The phase inversion step preferably includes both a VIPS and a LIPS step.

Both LIPS and VIPS are non-solvent induced phase-inversion processes.

In a LIPS step the porous support coated on both sides with the dope solution is contacted with a non-solvent that is miscible with the solvent of the dope solution.

Typically, this is carried out by immersing the porous support coated on both sides with the dope solutions into a non-solvent bath, also referred to as coagulation bath.

The non-solvent is preferably water, mixtures of water and an aprotic solvent selected from the group consisting of N-methylpyrrolidone (NMP), dimethylformamide (DMF), dimethylsulfoxide (DMSO) and dimethylacetamide (DMAC), water solutions of water-soluble polymers such as PVP or PVA, or mixtures of water and alcohols, such as ethanol, propanol or isopropanol.

The non-solvent is most preferably water.

The temperature of the coagulation bath is preferably between 2° and 90° C., more preferably between 4° and 70° C.

The transfer of solvent from the coated polymer layer towards the non-solvent bath and of non-solvent into the polymer layer leads to phase inversion and the formation of a three-dimensional porous polymer network.

The impregnation of the applied dope solution into the porous support results in a sufficient adhesion of the obtained hydrophilic layers onto the porous support.

In a preferred embodiment, the continuous web (100) coated on either side with a dope solution is transported downwards, in a vertical position, towards the coagulation bath (800) as shown in FIGS. 4 and 5.

In a VIPS step, the porous support coated with the dope solutions is exposed to non-solvent vapour, preferably humid air.

Preferably, the coagulation step included both a VIPS and a LIPS step.

Preferably the VIPS step is carried out before the LIPS step. In a particular preferred embodiment, the porous support coated with the dope solutions is first exposed to humid air (VIPS step) prior to immersion in a water bath (LIPS step).

In the manufacturing method shown in FIG. 4, VIPS is carried out in the area 400, between the slot coating dies (600, 600′) and the surface of the non-solvent in the coagulation bath (800), which is shielded from the environment with for example thermal isolated metal plates (500).

The extent and rate of water transfer in the VIPS step can be controlled by adjusting the velocity of the air, the relative humidity and temperature of the air, as well as the exposure time.

The exposure time may be adjusted by changing the distance d between the slot coating dies (600, 600′) and the surface of the non-solvent in the coagulation bath (800) and/or the speed with which the elongated web 100 is transported from the slot coating dies towards the coagulation bath.

The relative humidity in the VIPS area (400) may be adjusted by the temperature of the coagulation bath and the shielding of the VIPS area (400) from the environment and from the coagulation bath.

The speed of the air may be adjusted by the rotating speed of the ventilators (420) in the VIPS area (400).

The VIPS step carried out on one side of the separator and on the other side of the separator, resulting in the second porous polymer layer, may be identical (FIG. 4) or different (FIG. 5) from each other.

After the phase inversion step, preferably the LIPS step in the coagulation bath, a washing step may be carried out.

After the phase inversion step, or the optional washing step, a drying step is preferably carried out. Drying may be carried out at room temperature or at temperatures of 20° C. or more, 25° C. or more, 30° C. or more or even 50° C. or more. Drying is preferably carried out at room temperature. Drying may be carried out at a different relative humidity (RH), such as 80% or less, 60% or less, preferably 50% or less. The drying time may be from 1 to 120 minutes, preferably from 5 to 60 minutes. The temperature, relative humidity and time used in the drying time may be optimized to obtain a separator according to the present invention.

### Manufacturing of the Separator

FIGS. 4 and 5 schematically illustrates a preferred embodiment to manufacture a separator according to the present invention.

The porous support is preferably a continuous web (100).

The web is unwinded from a feed roller (700) and guided downwards in a vertical position between two coating units (600) and (600′).

With these coating units, a dope solution is coated on either side of the web.

The coating thickness on either side of the web may be adjusted by optimizing the viscosity of the dope solutions and the distance between the coating units and the surface of the web. Preferred coating units are described in EP-A 2296825, paragraphs [0043], [0047], [0048], [0060], [0063], and FIG. 1.

The web coated on both sides with a dope solution is then transported over a distance d downwards towards a coagulation bath (800).

In the coagulation bath, the LIPS step is carried out.

The VIPS step is carried out before entering the coagulation bath in the VIPS areas. In FIG. 4, the VIPS area (400) is identical on both sides of the coated web, while in FIG. 5, the VIPS areas (400(1)) and (400(2)) on either side of the coated web are different.

The relative humidity (RH) and the air temperature in de VIPS area may be optimized using thermally isolated metal plates. In FIG. 4, the VIPS area (400) is completely shielded from the environment with such metal plates (500). The RH and temperature of the air is then mainly determined by the temperature of the coagulation bath. The air speed in the VIPS area may be adjusted by a ventilator (420).

In FIG. 5 the VIPS areas (400(1)) and (400(2)) are different from each other. The VIPS area (400(1)) on one side of the coated web including a metal plate (500(1)) is identical to the VIPS area (400) in FIG. 4. The VIPS area (400(2)) on the other side of the coated web is different from the area (400(1)). There is no metal plate shielding the VIPS area (400(2)) from the environment. However, the VIPS area (400(2)) is now shielded from the coagulation bath by a thermally isolated metal plate (500(2)). In addition, there is no ventilator present in the VIPS area 400(2). This results in a VIPS area (400(1)) having a higher RH and air temperature compared to the RH and air temperature of the other VIPS area (400(2)).

A high RH and/or a high air speed in a VIPS area typically result in a larger maximum pore diameter.

The RH in one VIPS area is preferably above 85%, more preferably above 90%, most preferably above 95% while the RH in another VIPS area is preferably below 80%, more preferably below 75%, most preferably below 70%.

After the phase separation step, the reinforced separator is then transported to a rolled up system (700).

A liner may be provided on one side of the separator before rolling up the separator and the applied liner.

### Electrolytic Cell

The separator for alkaline water electrolysis according to the present invention may be a used in an alkaline water electrolyser.

An electrolytic cell typically consists of two electrodes, an anode and a cathode, separated by a separator. An electrolyte is present between both electrodes.

When electrical current is supplied to the electrolysis cell, hydroxyl ions of the electrolyte are oxidized into oxygen at the anode and water is reduced to hydrogen at the cathode. The hydroxyl ions formed at the cathode migrate through the separator to the anode. The separator prevents mixing of the hydrogen and oxygen gases formed during electrolysis.

An electrolyte solution is typically an alkaline solution. Preferred electrolyte solutions are aqueous solutions of electrolytes selected from sodium hydroxide or potassium hydroxide. Potassium hydroxide electrolytes are often preferred due to their higher specific conductivity. The concentration of the electrolyte in the electrolyte solution is preferably from 20 to 40 wt %, relative to the total weight of the electrolyte solution.

The temperature of the electrolyte is preferably from 50° C. to 120° C., more preferably from 75° C. to 100° C., most preferably from 80° to 90° C. However, a higher temperature, for example at least 100° C., more preferably from 125° C. to 165° C. may result in a more efficient electrolysis.

An electrode typically include a substrate provided with a so-called catalyst layer. The catalyst layer may be different for the anode, where oxygen is formed, and the cathode, where hydrogen is formed.

Typical substrates are made from electrically conductive materials selected from the group consisting of nickel, iron, soft steels, stainless steels, vanadium, molybdenum, copper, silver, manganese, platinum group elements, graphite, and chromium. The substrates may be made from an electrically conductive alloy of two or more metals or a mixture of two or more electrically conductive materials. A preferred material is nickel or nickel-based alloys. Nickel has a good stability in strong alkaline solutions, has a good conductivity and is relatively cheap.

A catalyst layer preferably includes nickel, cobalt, iron, and platinum group elements. The catalyst layer may include these elements as elemental metals, compounds (e.g. oxides), composite oxides or alloys made of multiple metal elements, or mixtures thereof. Preferred catalyst layers include plated nickel, plated alloys of nickel and cobalt or nickel and iron, complex oxides including nickel and cobalt such as LaNiO₃, LaCoO₃, and NiCo₂O₄, compounds of platinum group elements such as iridium oxide, or carbon materials such as graphene.

A particularly preferred catalyst layer comprises Raney Nickel. The Raney nickel structure is formed by selectively leaching aluminium or zinc from a Ni—Al or Ni—Zn alloy. Lattice vacancies formed during leaching result in a large surface area and a high density of lattice defects, which are active sites for the electrocatalytic reaction to take place.

Preferred porous electrodes and methods to prepare them are disclosed in for example EP-A 3575442, paragraphs 23 to 84.

The pore size of porous electrodes may have an influence on the electrolysis efficiency. For example, in EP-A 3575442 it is disclosed that preferred pore sizes of the porous electrodes are from 10 nm up to 200 nm.

The catalyst layer may also include organic substances such as polymers to improve the durability and the adhesion towards the substrate.

The separator according to the present invention is preferably used in a so-called zero gap electrolytic cell. In such a zero gap electrolytic cell, the electrodes are placed directly in contact with the separator thereby reducing the space between both electrodes. Mesh-type or porous electrodes are used to enable the separator to be filled with electrolyte and for efficient removal of the oxygen and hydrogen gases formed. It has been observed such zero gap electrolytic cells operate at higher current densities.

A typical alkaline water electrolyser include several electrolytic cells, also referred to as a stack of electrolytic cells.

Regarding the cell configuration, two types of electrolysers are typically used.

A unipolar (or “tank-type”) electrolyser consists of alternate positive and negative electrodes held apart by a separator. Positive electrodes are all coupled together in parallel, as are the negative electrodes, and the whole assembly is immersed in a single electrolyte bath (“tank”) to form a unit cell.

A plant-scale electrolyser is then built up by connecting these units electrically in series. The total voltage applied to the whole electrolysis cell is the same as that applied to the individual unit cells.

On the other hand, in a bipolar electrolyser a metal sheet (or “bipole”) connects electrically adjacent cells in series. The electrocatalyst for the negative electrode is coated on one face of the bipole and that for the positive electrode of the adjacent cell is coated on the reverse face. In this case, the total cell voltage is the sum of the individual unit cell voltages.

Therefore, a series-connected stack of such cells forms a module that operates at a higher voltage and lower current than the tank-type (unipolar) design. To meet the requirements of a large electrolysis plant, these modules are connected in parallel so as to increase the current.

### EXAMPLES

### Measurements

Volume % Pores Filled with Water

A sample having a diameter of 49 mm is punched from a separator. The water content of the sample is measured by weighing the sample before (W_{A}) and after (W_{B}) drying. The sample is dried, for example with a Mettler moisture analyser, until the weight of the sample remains constant for at least 2 minutes.

The sample is then completely wetted in water by placing it in water having a temperature between 55 and 65° C. for 5 minutes. The weight of the completely wetted sample is then measured (W_{C}).

The water content of the separator at the end of the preparation method just before packaging is W_{A}−W_{B}. The water content of a completely wetted separator is W_{C}−W_{B}.

The Volume % of pores filled with water (Vol % P) of a separator is then the ratio of the water content of the separator to the water content of the completely wetted separator (see Formula I).

$$\\ \begin{matrix}Vol \% P = \frac{{W}_{A} - {W}_{B}}{{W}_{C} - {W}_{B}} & Formula I\end{matrix}$$

### Viscosity

The viscosities of the dope solutions at 100 s⁻¹ and 20° C. were measured with a Kinexus LAB+ Rheometer available from Malvern Panalytical using a “Cup&Bob” geometry.

### Mechanical Properties

A sample was taken and folded with a “Z-fold”. After folding a weight of about 2.5 kg was rolled over the folded membrane. Afterwards both folds (F1 and F2 in FIG. 6) are inspected on a light box and a classification was given as shown in Table 1. The average of the classification of both folds F1 and F2 was calculated

TABLE 1

| Crack level | |
|---|---|
| 0 | no cracks, no damage |
| 1 | limited cracks at the edge of the fold |
| 2 | cracks/damage at the edge of the fold |
| | and limited cracks in between |
| 3 | 50% of the fold is cracked or damaged |
| 4 | cracks/damage over almost the complete fold |
| 5 | fold is immediately cracked/damaged |

### Preparation of the Separators S-1 and S-2

The separators S-1 and S-2 were prepared as schematically depicted in FIG. 4 using a dope solution comprising 40 wt % polysulfone, 10 wt % Zirconium oxide and 50 wt % N-butyl pyrrolidone on a PPS fabric having a thickness of respectively 300 and 100 μm.

The dope solutions were coated on both sides of the polymer fabric using slot die coating technology at a speed of 3 m/min.

The coated fabric was then transported towards a water bath kept at 65° C.

A VIPS step was carried out before entering the water bath in an enclosed area.

The coated support then entered the water bath for 2 minutes during which a liquid induced phase separation (LIPS) occurred.

The thickness of the obtained separators are shown in Table 2.

The volume percent of the pores filled with water (Vol % P) and the mechanical properties of different samples of S-1 and S-2, dried as shown in Table 2, were measured/evaluated as described above and are also shown in Table 2.

TABLE 2

| | Thickness | Drying | Vol % | Mechanical |
|---|---|---|---|---|
| Separator | (μm) | (21.9° C./47.7% RH) | P | properties |
| S-1 | 500 | — | 100 | 1 |
| S-2 | 220 | — | 100 | 0 |
| S-1 | 500 | 45 min | 50 | 2.5 |
| S-2 | 220 | 15 min | 50 | 0 |
| S-1 | 500 | 120 min | 0 | 4 |
| S-2 | 220 | 45 min | 0 | 3.5 |

It is clear from the results of Table 2 that separators having a volume percent of the pores filled with water (Vol % P) of at least 25% are more crack resistant and have therefore an improved performance in water electrolyses.

1-15. (canceled)

16. A separator for alkaline electrolysis comprising a porous support and a porous layer provided on the porous support, characterized in that at least 25 volume percent of the pores of the separator are filled with water.

17. The separator of claim 16, wherein at least 40 volume percent of the pores of the separator are filled with water.

18. The separator of claim 16, wherein the separator includes a first porous layer provided on one side of the porous support and a second porous layer provided on the other side of the porous support.

19. The separator of claim 18, wherein the first and the second porous layers are the same.

20. The separator of claim 16, wherein the porous layer includes a polymer resin and hydrophilic inorganic particles.

21. The separator of claim 20, wherein the polymer resin is selected from the group consisting of polysulfone, polyethersulfone, and polyphenylsulfide.

22. The separator of claim 20, wherein the hydrophilic inorganic particles are selected from the group consisting of zirconium oxide, zirconium hydroxide, magnesium oxide, magnesium hydroxide, titanium oxide, titanium hydroxide, and barium sulfate.

23. The separator of claim 22, wherein the hydrophilic inorganic particles have a particle size D₅₀ of 0.7 μm or lower.

24. The separator of claim 16, wherein a thickness of the separator (t2) is from 75 to 500 μm.

25. The separator of claim 16, wherein a thickness of the separator (t2) is from 100 to 250 μm.

26. The separator of claim 16, wherein the porous support is a polymeric fabric selected from a polypropylene (PP), a polyphenylene sulphide (PPS), and a polyether ether ketone (PEEK) fabric.

27. The separator of claim 16, wherein the porous support has a thickness (t1) of 350 μm or less.

28. The separator of claim 16, wherein the porous support has a thickness (t1) of 100 μm or less.

29. A package including a separator as defined in claim 16 and a packaging material, wherein the water vapour transmission rate (WVTR) of the packaging material is less than 1 g/m²/24 hours.

30. The package of claim 29, further including an interleave between two separators.

31. A package including a separator as defined in claim 20 and a packaging material, wherein the water vapour transmission rate (WVTR) of the packaging material is less than 1 g/m²/24 hours.

32. The package of claim 31, further including an interleave between two separators.

33. A package including a separator as defined in claim 26 and a packaging material, wherein the water vapour transmission rate (WVTR) of the packaging material is less than 1 g/m²/24 hours.

34. The package of claim 33, further including an interleave between two separators.
